(19) United States
(12) Patent Application Publication
(10) Pub. No.: US 2010/0123802 A1
(43) Pub. Date: May 20, 2010

(54) DIGITAL IMAGE SIGNAL PROCESSING METHOD FOR PERFORMING COLOR CORRECTION AND DIGITAL IMAGE SIGNAL PROCESSING APPARATUS OPERATING ACCORDING TO THE DIGITAL IMAGE SIGNAL PROCESSING METHOD

(75) Inventor: Jong-sun Kim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/616,211

(22) Filed: Nov. 11, 2009

(30) Foreign Application Priority Data
Nov. 19, 2008 (KR) 10-2008-0115354

(51) Int. Cl. H04N 9/68; G06K 9/00

(52) U.S. Cl. 348/234; 382/167; 382/165; 348/E09.053

(57) ABSTRACT

Provided are a digital image signal processing method for performing independent, optimized color corrections with respect to a plurality of subjects of an image, which require color corrections, and a digital image signal processing apparatus operating according to the digital image signal processing method. The method includes: inputting an image including a plurality of subjects which require different types of color corrections; detecting an area of each of the subjects; forming a color distribution using image information of the areas of the subjects; classifying the color distribution into a plurality of color areas; and performing corresponding color corrections with respect to corresponding color areas. For this purpose, a color distribution of subjects, which are to be corrected, is formed and then classified into a plurality of color areas. Corresponding color corrections are performed with respect to the color areas using color information of the color areas.

### CROSS-REFERENCE TO RELATED PATENT APPLICATION

This application claims the benefit of Korean Patent Application No. 10-2008-0115354, filed on Nov. 19, 2008, in the Korean Intellectual Property Office, the disclosure of which is incorporated herein in its entirety by reference.

### BACKGROUND

The present invention relates to a digital image signal processing method for performing color correction and a digital image signal processing apparatus operating according to the digital image signal processing method.

Digital image signal processing apparatuses perform various types of image signal processing and have developed into digital image signal processing apparatuses which apply color corrections among the various types of image signal processing in order to obtain images desired by users. In particular, digital cameras have been developed to perform color corrections with respect to skin color of people. A conventional skin color correction is performed in the same way with respect to an image including people having different skin color, such as black, white, yellow, etc., which widens the ranges of areas which are to be corrected. As a result, the conventional skin color correction is performed with respect to areas of the image which are not skin areas. There is another conventional skin color correction method by which a user directly selects respective human races and performs skin color corrections appropriate to the selected human race. However, this conventional skin color correction method has a problem in that calculations are complicated.

### SUMMARY

Various embodiments of the present invention provide a digital image signal processing method for independently, easily, and effectively performing color corrections with respect to subjects which require different types of color corrections, and a digital image signal processing apparatus operating according to the digital image signal processing method.

Various embodiments of the present invention also provide a digital image signal processing method for performing independent, optimized skin color corrections with respect to a plurality of skin colors of an image, and a digital image signal processing apparatus operating according to the digital image signal processing method.

According to another aspect of the present invention, there is provided a digital image signal processing method including: inputting an image including a plurality of subjects which require different types of color corrections; detecting an area of each of the subjects; forming a color distribution using image information of the areas of the subjects; classifying the color distribution into a plurality of color areas; and performing corresponding color corrections with respect to areas of the image respectively corresponding to the color areas. Here, the subjects may be corrected using different types of color correction methods. Alternatively, color corrections may be independently performed with respect to different subjects to be corrected. However, both cases may be used in the same meaning hereinafter.

The plurality of color areas may include first and second color areas. A first color correction may be performed with respect to an area of the image corresponding to the first color area, and a second color correction may be performed with respect to an area of the image corresponding to the second color area.

The digital image signal processing method may further include extracting the image information of the areas of the subjects.

The image information may be color information which is represented through each of channels.

According to another aspect of the present invention, there is provided a digital image signal processing method for performing different types of skin color corrections with respect to an image representing people having different skin colors, including: inputting an image including people having different skin colors; detecting face areas of people from the image; forming a skin color distribution using image information of the face areas; classifying the skin color distribution into a plurality of skin color areas; and performing skin color corrections with respect to skin color areas of the image respectively corresponding to the plurality of skin color areas.

The image information of the face areas may include at least one of luminance, hue, saturation.

The digital image signal processing method may further include extracting skin colors using the image information of the face areas.

The extracted skin colors may be respectively represented through the channels in order to form the skin color distribution.

The skin color distribution may include a plurality of Gaussian distributions.

The skin color distribution may be classified into the plurality of skin color areas using a mean value and a variance value of each of the plurality of Gaussian distributions.

The plurality of people may include people of different ethnic backgrounds.

According to another aspect of the present invention, there is provided a digital image signal processing apparatus including: an image input unit which inputs an image including a plurality of subjects which require different types of color corrections; an area detector which detects areas of the plurality of subjects; a color distribution former which forms a color distribution using image information of the areas of the plurality of subjects; a color area classifier which classifies the color distribution into a plurality of color areas; and a color corrector which performs corresponding color corrections with respect to areas of the image respectively corresponding to the color areas.

The digital image signal processing apparatus may further include a subject extractor which extracts subjects, which are to be corrected, from the areas of the plurality of subjects.

The image information may be color information which is represented through each of channels.

According to another aspect of the present invention, there is provided a digital image signal processing apparatus including: an image input unit which inputs an image including a plurality of people having different skin colors; a face area detector which detects face areas of the plurality of people from the image; a skin color distribution former which forms a skin color distribution using image information of the face areas; a skin color area classifier which classifies the skin color distribution into a plurality of skin color areas; and a skin color corrector which performs skin color corrections with respect to skin color areas of the image respectively corresponding to the plurality of skin color areas.

The image information of the face areas may include at least one of luminance, hue and saturation.

The digital image signal processing apparatus may further include a skin color extractor which extracts skin colors using the image information of the face areas.

The skin color distribution former may respectively represent the extracted skin colors through the channels in order to form the skin color distribution.

The skin color distribution may include a plurality of Gaussian distributions.

The plurality of people may include people of different ethnic backgrounds.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital image signal processing apparatus according to an embodiment of the present invention;

FIG. 2 is a block diagram of a digital signal processor (DSP) of the digital image signal processing apparatus of FIG. 1, according to an embodiment of the present invention;

FIG. 3 is a block diagram of a DSP of the digital image signal processing apparatus of FIG. 1, according to another embodiment of the present invention;

FIG. 4 is a block diagram of a hardware configuration of a digital image signal processing apparatus according to an embodiment of the present invention;

FIG. 5 is a flowchart of a digital image signal processing method according to an embodiment of the present invention;

FIG. 6 is a flowchart of a digital image signal processing method according to another embodiment of the present invention;

FIG. 7 is a pictorial illustration of a camera screen which displays face areas respectively detected from a plurality of human races using a digital image signal processing method, according to an embodiment of the present invention;

FIG. 8 is a graph illustrating a skin color distribution of a plurality of human races which is represented on a color space using a digital image signal processing method, according to an embodiment of the present invention;

FIG. 9 is a graph illustrating a method of determining a correction range according to a skin color distribution represented on a color space, using a digital image signal processing method, according to an embodiment of the present invention;

FIG. 10 is a graph illustrating a method of determining a correction range according to a skin color distribution represented on a color space using a conventional digital image signal processing method;

FIGS. 11A and 11B respectively illustrate screens which respectively display face areas which are not corrected and are corrected the conventional digital image signal processing method; and

FIGS. 12A and 12B respectively illustrate screens which respectively display face areas which are not corrected and are corrected using a digital image signal processing method according to an embodiment of the present invention.

### DETAILED DESCRIPTION OF THE EMBODIMENTS

A digital image signal processing method for performing color correction and a digital image signal processing apparatus operating according to the digital image signal processing method will now be described in detail with reference to the embodiments shown in the attached drawings.

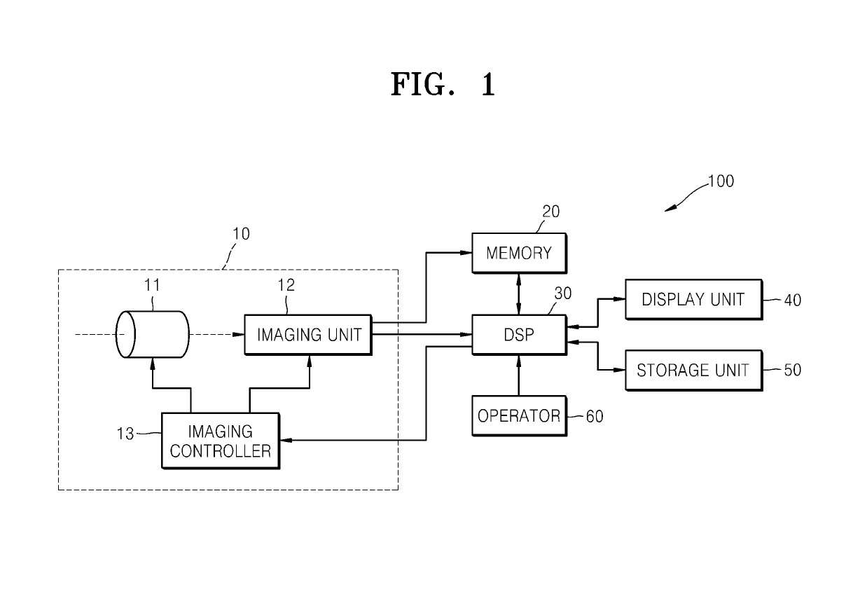

FIG. 1 is a block diagram of a digital image signal processing apparatus 100 according to an embodiment of the present invention. Referring to FIG. 1, the digital image signal processing apparatus 100 according the present embodiment includes a photographing unit 10, a memory 20, a digital signal processor (DSP) 30, a display unit 40, a storage unit 50, and an operator 60. The photographing unit 10 is an image input unit, the memory 20 temporarily stores data to perform an operation for processing a data signal, and the DSP 30 controls an overall signal processing operation. The display unit 40 displays an image, the storage unit 50 stores the image, and the operator 60 receives a control signal from an external source such as a user or the like.

The photographing unit 10 includes an optical unit 11 which receives an optical signal from a subject, an imaging unit 12 which receives the optical signal from the optical unit 11, and an imaging controller 13 which controls the optical unit 11 and the imaging unit 13.

In detail, the optical unit 11 may include a lens unit which focuses the optical signal, an aperture which adjusts an amount (intensity) of the optical signal, a shutter which controls an input of the optical signal, etc. The lens unit includes a zoom lens which controls a view angle to narrow or widen according to a focal length, a focus lens which controls a focus of the subject, etc. These lenses may be integrated into one lens or may be classified into a plurality of lens groups.

The imaging unit 12 includes an imaging device which receives the optical signal from the optical unit 11 in order to capture an image of the subject. The imaging device may be a charge-coupled device (CCD), a complementary metal oxide semiconductor (CMOS) image sensor (CIS), or the like. The imaging device converts the optical signal into an electric signal. The imaging unit 12 may further include an analog signal processor which performs sampling and holding with respect to an image signal output from the imaging device in order to perform correlated double sampling with respect to the image signal and then converts the image signal into a digital signal.

The imaging controller 13 may largely include an optical driver which drives the optical unit 11 and a timing generator which controls the imaging unit 12. For example, the optical driver may drive a position of the lens unit, closing and/or opening of the aperture, operation of the shutter, etc., according to a control signal input from the DSP 30 based on a real-time input image or the control signal input from an external source such as the user or the like. The timing generator may control the imaging device and the analog signal processor. For example, the imaging device may adjust charge accumulation times and output times of accumulated charges under the control of the timing generator. As a result, the imaging unit 12 may control sensitivity and the like. The timing generator may output a timing signal for controlling the imaging device 12 according to the control signal input from the DSP 30 based on the real-time input image or the control signal input from the external source such as the user or the like.

The memory 20 may temporarily store the image signal which is output from the imaging unit 10. The image signal may be recorded in the storage unit 50 through the DSP 30 or may be transmitted to the display unit 40 so as to be displayed as a predetermined image.

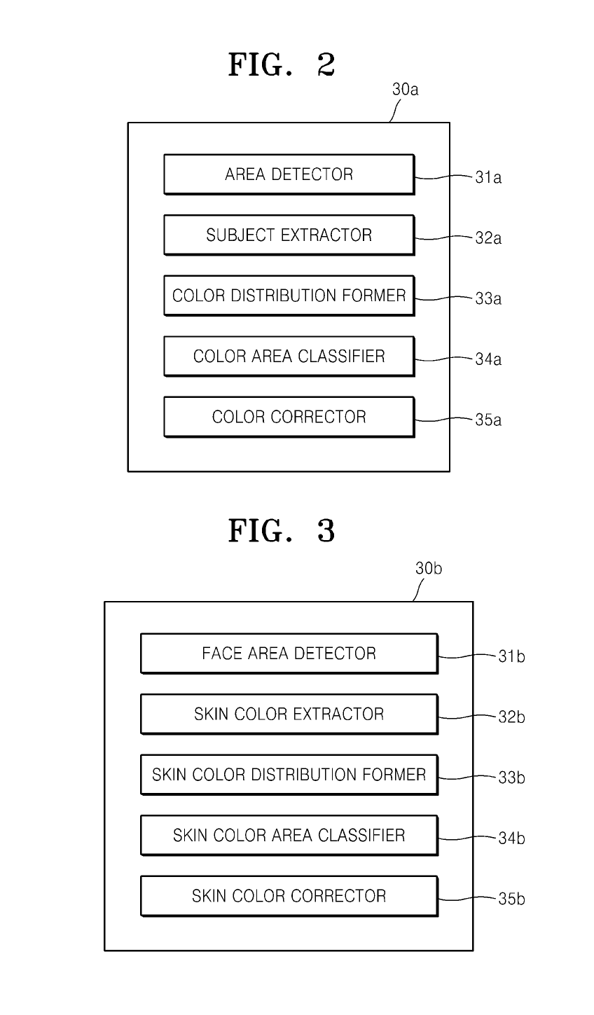

The DSP 30 may perform image signal processing with respect to the image signal input from the memory 20 or the image signal directly input from the imaging device 10 according to a pre-stored algorithm. In other words, the DSP 30 may perform image signal processing appropriate for the display unit 30 or image signal processing appropriate for recording in the storage unit 50. For example, the DSP 30 may attenuate noise of the image signal and then perform image signal processing, such as gamma correction, color filter array interpolation, a color matrix application, color enhancement, or the like, with respect to the image signal. The DSP 30 may compress image data, which is generated through image signal processing, in order to generate an image file or may recover the image data from the image file. The DSP 30 also performs color correction which will be described later with reference to FIGS. 2 and 3.

The display unit 40 receives the image signal, which has undergone image signal processing appropriate for a display panel, from the DSP 30 and displays an image corresponding to the image signal. The display unit 40 may include the display panel which realizes the image, a driver which drives the display panel, a display controller, and the like. The display unit 40 may be a liquid crystal display (LCD), an organic light-emitting display (OLED), an electrophoretic display device (EDD), or the like.

The storage unit 50 stores a program for operating the digital image signal processing apparatus 100, data for executing the program, etc. The storage unit 50 records the image file input from the DSP 30 for preservation purposes. The storage unit 50 may be a memory which is installed in the digital image signal processing apparatus 100 or may be a memory unit which is removable from the digital image signal processing apparatus 100. For example, the storage unit 50 may be a memory card, a storage unit such as a hard disk or the like, a recording medium such as a compact disk-read only memory (CD-ROM), or the like. If the storage unit 50 is the removable memory unit, the digital image signal processing apparatus 100 may further include an interface through which data is received from the removable memory unit.

The operator 60 receives the control signal from the external source such as the user or the like and may be realized in various forms such as a keyboard, a mouse, a function key, a button, a touch screen, etc.

The DSP 30, which controls color correction according to the present invention, will now be described in more detail with reference to FIGS. 2 and 3.

FIG. 2 is a block diagram of a DSP 30a according to an embodiment of the present invention. The DSP 30a includes an area detector 31a, a color distribution former 33a, a color area divider 34a, and a color corrector 35a. The area detector 31a detects an area of each of a plurality of subjects, which require different types of color corrections, from an image including the plurality of subjects. The color distribution former 33a forms a color distribution using at least one piece of image information of the detected areas. The color area classifier 34a classifies the color distribution into a plurality of color areas. The color corrector 35a performs corresponding color corrections with respect to areas of the image respectively corresponding to the color areas. The DSP 30a further includes a subject extractor 32a for extracting subjects which are to be corrected and forming a color distribution of the subjects through the color distribution former 33a.

In detail, the area detector 31a detects areas of the plurality of subjects from the image including the plurality of subjects, e.g., face areas or the like. The color distribution former 33a forms the color distribution using color information of the areas which are respectively represented through channels. The color distribution may be a lookup table, a color space, or the like of the color information. In summary, the area detector 31a may detect an area of a subject, the subject extractor 32a may extract a subject of which color is to be corrected, and the color distribution former 33a may form a color distribution using color information of the extracted subject. For example, if a skin color of a face area of a subject is to be corrected, the skin color may be extracted, and a color distribution of color information of the skin color may be formed.

The color area classifier 34a may classify color distributions of the subjects constituting the color distribution into a plurality of color areas. Color distributions, which belong to the same category and are to undergo the same type of color correction, may be combined into one color area. For example, an image including first and second subjects is input, an area of the first subject and an area of the second subject are detected, subjects to be corrected are respectively extracted from the areas, and color distributions of the subjects are formed. If at least one of luminance, hue and saturation of the subject of the first subject is considerably different from at least one of luminance, hue and saturation of the subject of the second subject, and different types of color corrections are to be performed with respect to the subjects of the first and second subjects, color distributions, which require the same types of color corrections, may be classified into the same areas.

If color information of the color distributions of the first subject is considerably different from that of the color distributions of the second subject, the color distributions of the first subject may be classified into a first color area, and the color distributions of the second subject may be classified into a second color area. Here, a method of classifying color areas may be a multi-Gaussian scheme.

The color corrector 35a respectively performs corresponding color corrections with respect to the classified color areas. In detail, the color corrector 35a may perform a first color correction with respect to the first color area and a second color correction with respect to the second color area.

It has been described in the present embodiment that the DSP 30a classifies a color distribution into color areas, which require the same types of color corrections, and respectively performs corresponding color corrections on the color areas.

FIG. 3 is a block diagram of a DSP 30b according to another embodiment of the present invention. The DSP 30b of the present embodiment classifies a skin color distribution into skin color areas and respectively performs corresponding skin color corrections with respect to the skin color areas.

Referring to FIG. 3, the DSP 30b includes a face area detector 31b which detects face areas of a plurality of subjects from an image including the plurality of subjects. The face area detector 31b may detect the face areas of the subjects using an AdaBoost algorithm or skin color information.

The DSP 30b includes a skin color extractor 32b which extracts skin colors from the detected face areas.

The DSP 30b forms a lookup table or a skin color space of the skin colors which are extracted by the skin color detector 32b. Thus, the DSP 30b may form a skin color distribution using the lookup table or the skin color space. Here, a skin color distribution former 33b may form the skin color distribution.

The skin color distribution may be formed of ellipsoidal Gaussian distributions. Therefore, a skin color area classifier 34b may classify the skin color distribution into skin color areas using a multi-Gaussian scheme such as Gaussian Mixture Model (GMM), K-means (K-M), K-nearest neighbor (K-NN) algorithms, etc.

A skin color corrector 35b respectively performs corresponding skin color corrections with respect to the skin color areas. For example, the skin color corrector 35b may perform the skin color corrections using bilateral filtering (Durand et al., “Fast Bilateral Filtering for the Display of High-Dynamic-Range Images” ACM SIGGRAPH 2002, herein incorporated by reference) or Gaussian filtering.

In the present embodiment, skin color corrections may be independently performed with respect to skin colors of a plurality of subjects of an image, having a plurality of ethnic backgrounds, so as to obtain an optimized skin color correction effect. In other words, skin color corrections respectively appropriate for the plurality of ethnic backgrounds may be performed so as to obtain an image desired by a user.

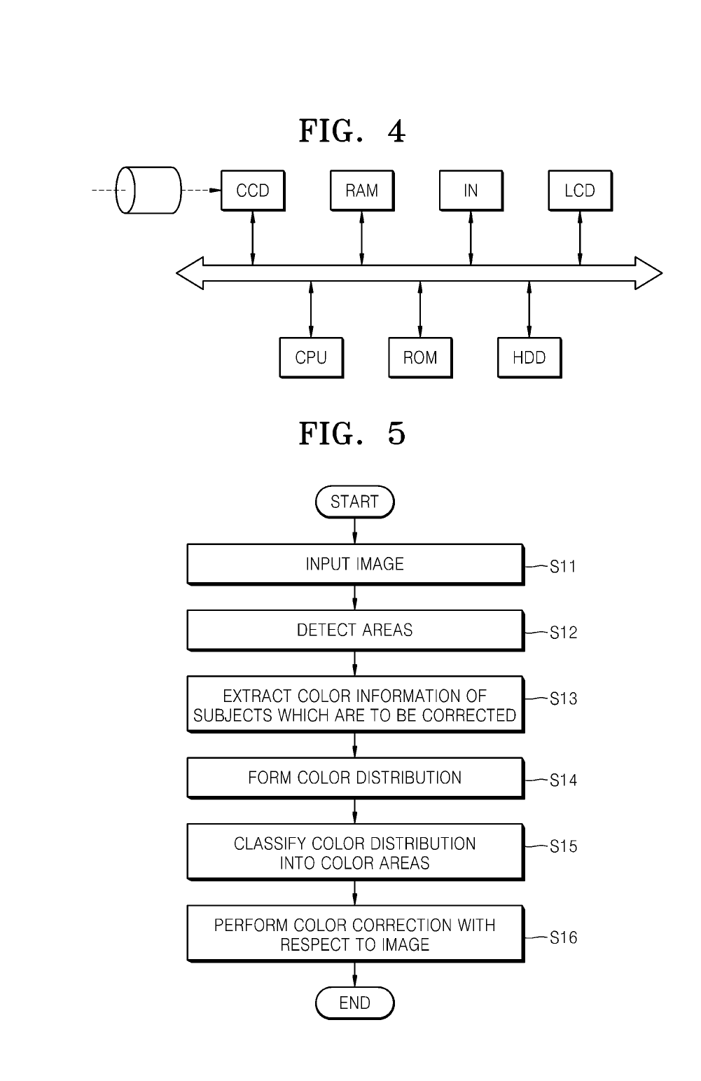

FIG. 4 is a block diagram of a hardware configuration of a digital image signal processing apparatus according to an embodiment of the present invention. The hardware configuration of the digital image signal processing apparatus, which performs the above-described skin color correction algorithm, will now be described in the present embodiment.

Referring to FIG. 4, the digital image signal processing apparatus includes a CCD which converts an optical signal input through an optical unit into an electric signal. A central processing unit (CPU) controls an overall operation as well as skin color corrections as described above using data stored in a ROM, random access memory (RAM), and hard disk drive (HDD). The RAM has a memory necessary for performing an operation controlled by the CPU and temporarily stores programs, data, and the like which are loaded from the CCD and HDD. The ROM stores a boot program, setup data, and the like. An user interface (UI) receives a control signal from a user and may be a touch screen, a function key, a button, or the like. The HDD is an external memory unit which stores an operating system (OS), or a program or data necessary for performing the skin color corrections. The program or data is transformed into an executable format and then stored in the RAM and is used to control the CPU to perform a corresponding operation. The HDD may store an image file indicating an input image. An LCD is a display device which displays results processed by the CPU, the input image, or a stored image.

In the present embodiment, the hardware configuration for realizing the digital image signal processing apparatus has been described; however, the digital image signal processing apparatus is not limited thereto and may be realized so as to have different types of hardware configurations capable of performing the above-described functions.

FIG. 5 is a flowchart of a digital image signal processing method according to an embodiment of the present invention. Referring to FIG. 5, in operation S11, an image including a plurality of subjects is input. Here, the image includes the subjects which require different types of color corrections.

In operation S12, areas of the subjects are detected from the image. In operation S13, color information of subjects, which are to be corrected, is extracted.

In operation S14, a color distribution is formed. Color information of the detected areas of the subjects may be extracted in order to form the color distribution. Alternatively, the color distribution may be formed using color information of the subjects of the areas of the subjects.

In operation S15, the color distribution is divided into color distributions, each of which requires the same type of color correction, in order to classify the color distributions into the same color areas. The classification of the color areas may be performed using a multi-Gaussian scheme so as to obtain a mean value and a variance value from each of a plurality of Gaussian distributions. The image may be divided into color areas which are to be corrected, using the mean and variance values.

In operation S16, color correction is performed with respect to the image. If the image is divided into first and second color areas, a first color correction may be performed with respect to areas of the image having color information corresponding to the first color area, and a second color correction may be performed with respect to areas of the image having color information corresponding to the second color area.

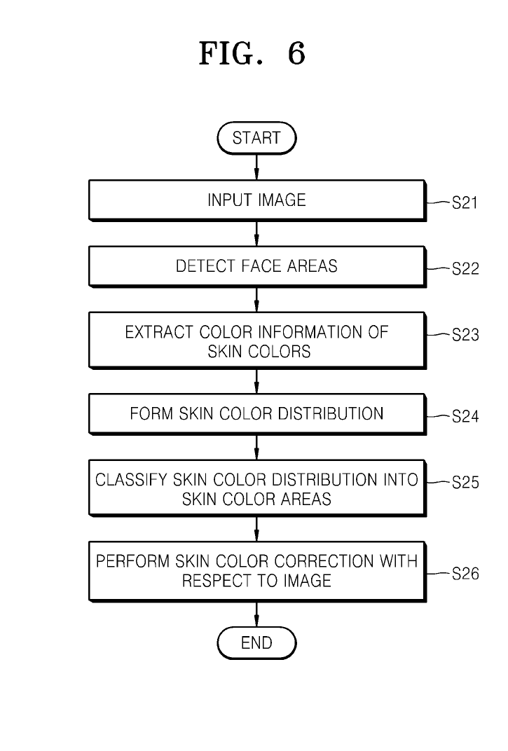

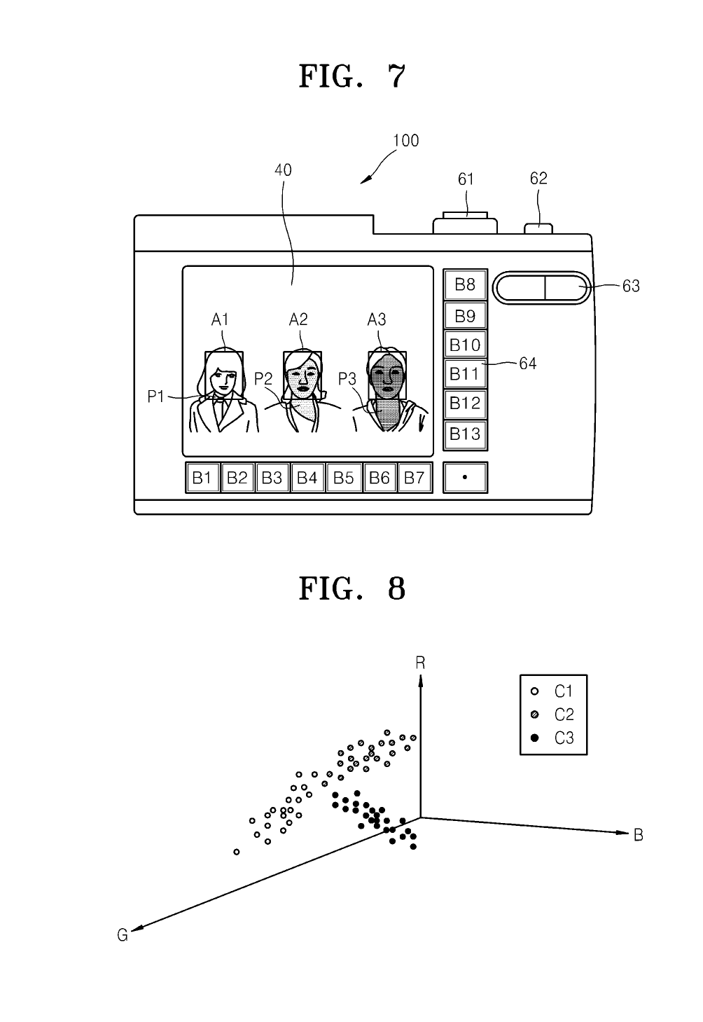

FIG. 6 is a flowchart of a digital image signal processing method according to another embodiment of the present invention. In the present embodiment, skin color corrections are independently performed with respect to a plurality of skin colors. The performance of the skin color corrections will be described in detail with reference to FIGS. 7 through 12B along with FIG. 6.

Referring to FIG. 6, in operation S21, an image including a plurality of people respectively having a plurality of skin colors is input.

In operation S22, face areas of the people are detected from the image. Here, the face areas may be detected using an AdaBoost algorithm or skin color information.

In detail, referring to FIG. 7, an image is captured using a digital camera 100 that is an example of a digital image signal processing apparatus. The digital camera 100 includes a display unit 40, various kinds of function buttons 63 and 64, a shutter-release button 61, and a power button 62. The display unit 40 is installed on a rear surface of the digital camera 100, and the buttons 63 and 64 are disposed around the display unit 40. The shutter-release button 61 and the power button 62 are disposed on the top of the digital camera 100. A user checks an image displayed on the display unit 40 of the digital camera 100 in a live view mode. If the user determines an image to be captured, the user presses the shutter-release button 61 in order to capture the image. If a beauty mode in which a skin color correction is to be performed is pre-set, a skin color correction is performed with respect to the image which is input through photographing.

The user checks subjects of a white person “P1,” a yellow person “P2,” and a black person “P3” through the display unit 40 in the live-view mode. If the user lightly presses the shutter-release button 61, face areas “A1,” “A2,” and “A3” are respectively detected from the white, yellow, and black people “P1,” “P2,” and “P3.” The detected face areas “A1,” “A2,” and “A3” may be respectively displayed in corresponding areas with boxes. If the user heavily presses the shutter-release button 61, the image displayed on the display unit 40 is captured and input.

Referring to FIG. 6 again, in operation S23, skin colors of the face areas are detected. In detail, color information of the skin colors is extracted. In the present embodiment, subjects, which are to be corrected, are the skin colors, i.e., color information of skin colors of people is extracted.

In operation S24, a skin color distribution is formed using the color information of the skin colors. The skin color distribution may be represented on a lookup table or on a graph which represents color information of skin colors on a color space.

Referring to FIG. 8, color information of skin colors is extracted from face areas of an input image and then is represented on a color space in order to form a skin color distribution. The color information includes red (R), green (G), and blue (B) color values which are respectively represented through channels. In FIG. 8, “C1” denotes a color information distribution of a white person “P1,” “C2” denotes a color information distribution of a yellow person “P2,” and “C3” denotes a color information distribution of a black person “P3.”

Skin color models may be defined from the skin color distribution using a multi-Gaussian scheme. In operation S25, the skin color distribution is classified into skin color areas which require different types of skin color corrections.

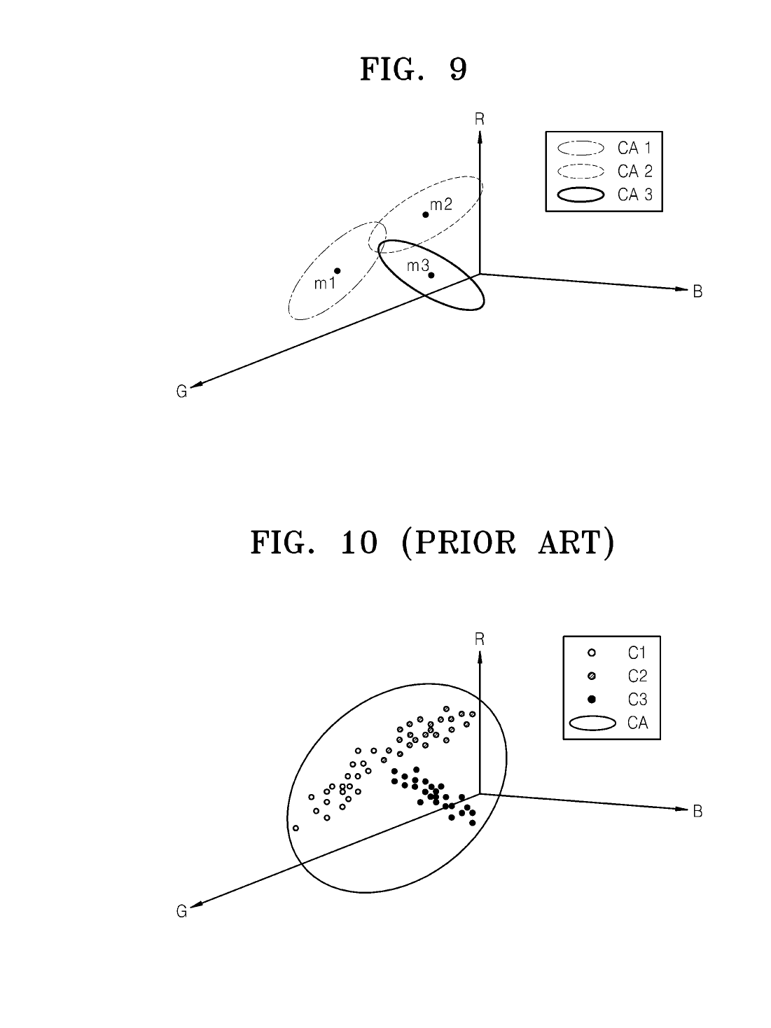

In detail, referring to FIG. 9, the skin color distribution is represented as a plurality of Gaussian distributions. Thus, a mean value and a variance value may be obtained from each of the plurality of Gaussian distributions in order to classify the skin color distribution into skin color areas using the mean and variance values. A mean value “m1” of a color information distribution of a white person “P1,” a mean value “m2” of a color information distribution of a yellow person “P2,” and a mean value “m3” of a color information distribution of a black person “P3” are obtained. Variance values of the color information distributions of the white, yellow, and black people “P1,” “P2,” and “P3” are respectively obtained. Thus, areas, which range from the mean values “m1,” “m2,” and “m3” to the variance values, may be set to skin color areas. In FIG. 9, “CA1” denotes a skin color area of the white person “P1,” “CA2” denotes a skin color area of the yellow person “P2,” and “CA3” denotes a skin color area of the black person “P3.”

FIG. 10 is a graph illustrating a method of determining a correction range according to a skin color distribution represented on a color space using or a conventional digital image signal processing method. The conventional digital image signal processing method does not apply a multi-Gaussian scheme differently from the present invention. However, color information “C1,” “C2,” “C3” of white, yellow, and black people “P1,” “P2,” “P3” are represented on a color space, and an area including the color information “C1,” “C2,” “C3” is set to a skin color area “CA.” The set skin color area “CA” includes the color information “C1,” “C2,” and “C3” of the skin colors and a large amount of color information not of skin colors (color information of areas which are not represented with “C1,” “C2,” and “C3”). Thus, non-skin color areas may be determined as skin color areas, and then skin color corrections may be respectively performed with respect to the non-skin color areas.

Referring to FIG. 6, in operation S26, an appropriate skin color correction is performed with respect to the image having color information respectively corresponding to the classified color areas. A first skin color correction may be performed with respect to an area of the image (e.g., a skin color area of the white person “P1” such as a face area, finger area, or the like) having color information corresponding to the color area “C1” of the white person “P1.” A second skin color correction may be performed with respect to a skin color of the yellow person “P2” having color information corresponding to the color area “C2” of the yellow person “P2.” A third skin color correction may be performed with respect to a skin color of the black person “P2” of the image.

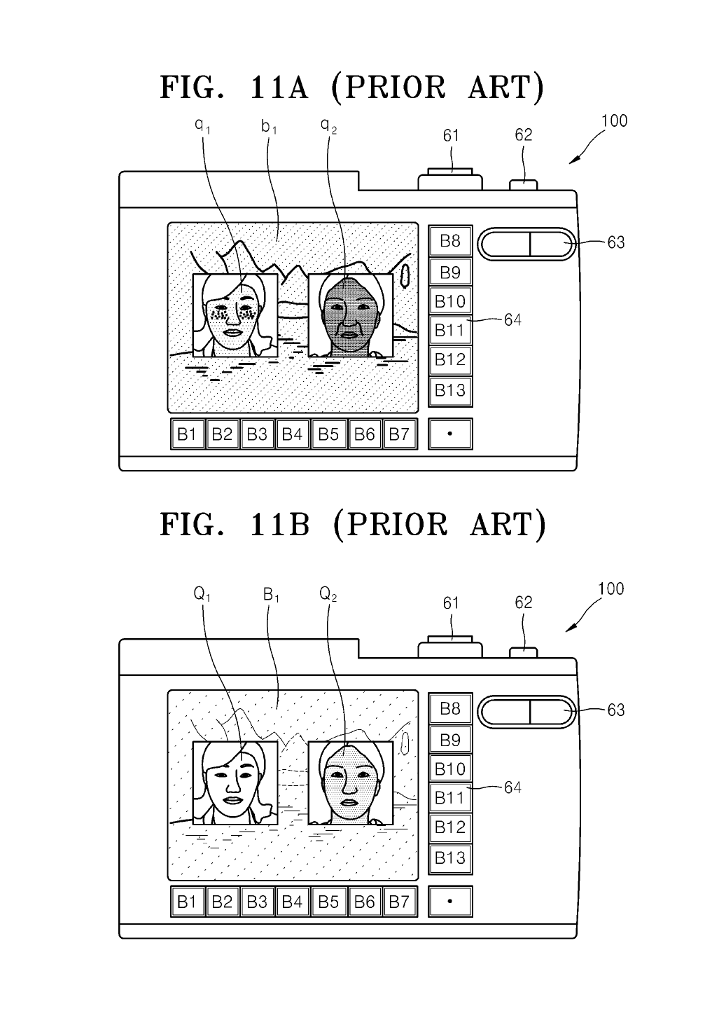

According to a conventional digital image signal processing method illustrated in FIG. 11A, a skin color correction is performed with respect to an image obtained by photographing white and black people “q1” and “q2,”. However, since a range of a skin color area “CA” widens, the skin color correction is performed with respect to the skin color area “CA” and a similar skin color area. Therefore an image including white and black people “Q1” and “Q2,” which have undergone the same type of color correction, can be obtained as shown in FIG. 11B. Although a background area “B1” is an area which does not indicates a skin color of a person, a skin color correction is performed with respect to the background area “B1,” which distorts the original image.

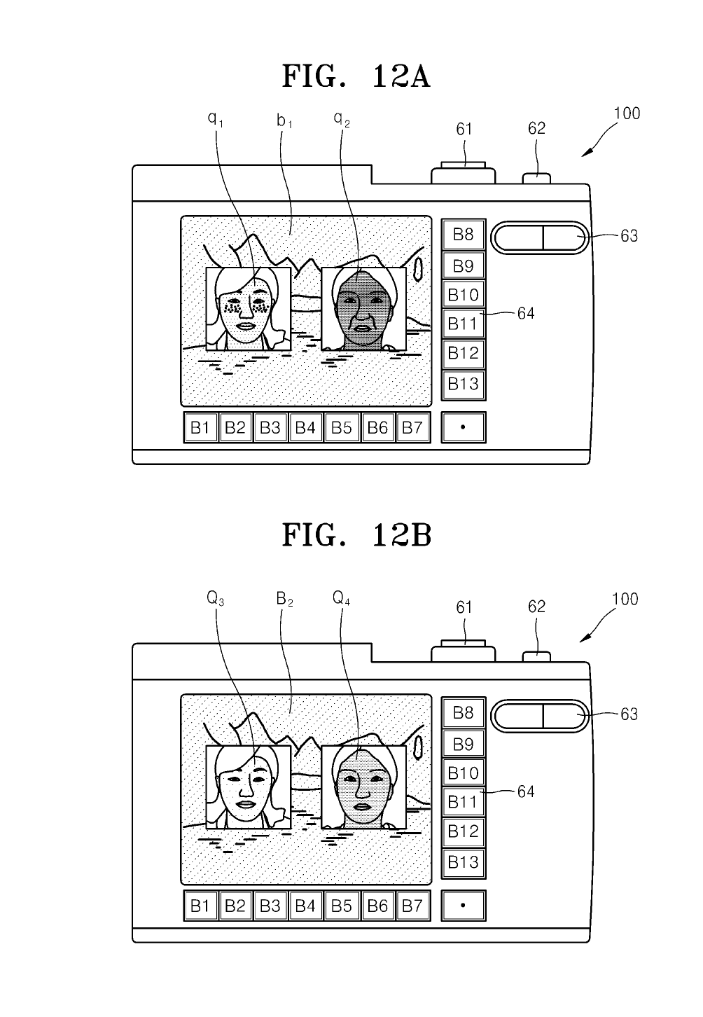

However, in a digital image signal processing method according to an embodiment of the present invention, if a skin color correction is performed with respect to an image shown in FIG. 12A, skin color corrections are independently performed with respect to white and black people “q1” and “q2.” A skin color correction is not performed with respect to a background area “b1” which is not a skin color area. Therefore, an image including white and black people “Q3” and “Q4,” which have independently undergone skin color corrections, can be obtained as shown in FIG. 12B. A skin color correction is not performed with respect to a background area “B2” of the image. Therefore, skin color corrections are selectively and independently performed with respect to skin colors so as to obtain an optimized skin color correction effect.

As described above, in a digital image signal processing method for performing color correction and a digital image signal processing apparatus operating according to the digital image signal processing method according to various embodiments of the present invention, different types of optimized color corrections can be independently performed with respect to subjects of an image which are to be corrected.

In addition, skin color corrections respectively appropriate for different skin colors can be independently performed with respect to people of an image having the different skin colors, so as to obtain an optimized skin color correction effect.

The system or systems described herein may be implemented on any form of computer or processor and the components can include functional programs, codes, and code segments. The system may further comprise a memory for storing program data and executing it, a permanent storage such as a disk drive, a communications port for handling communications with external devices, and user interface devices. When software modules are involved, these software modules may be stored as program instructions or computer readable codes executable on the processor on a computer-readable media such as read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

The words “mechanism” and “element” are intended to be used generally and are not limited solely to mechanical embodiments. Numerous modifications and adaptations will be readily apparent to those skilled in this art without departing from the spirit and scope of the present invention.

What is claimed is:

1. A digital image signal processing method for a digital imaging device, comprising:
inputting an image comprising a plurality of subjects which require different types of color corrections;
detecting an area of each of the subjects;
forming a color distribution using image information of the areas of the subjects;
classifying the color distribution into a plurality of color areas; and
performing corresponding color corrections with respect to areas of the image respectively corresponding to the color areas.

2. The digital image signal processing method of claim 1, wherein the plurality of color areas comprise first and second color areas, wherein a first color correction is performed with respect to an area of the image corresponding to the first color area, and a second color correction is performed with respect to an area of the image corresponding to the second color area.

3. The digital image signal processing method of claim 1, further comprising extracting subjects, which are to be corrected, from the areas of the subjects.

4. The digital image signal processing method of claim 3, wherein the image information is color information which is represented through each of channels.

5. A digital image signal processing method comprising:
inputting an image comprising a plurality of people having different skin colors;
detecting face areas of the plurality of people from the image;
forming a skin color distribution using image information of the face areas;
classifying the skin color distribution into a plurality of skin color areas; and
performing skin color corrections with respect to skin color areas of the image respectively corresponding to the plurality of skin color areas.

6. The digital image signal processing method of claim 5, wherein the image information of the face areas comprises at least one of luminance, hue, saturation.

7. The digital image signal processing method of claim 5, further comprising extracting skin colors using the image information of the face areas.

8. The digital image signal processing method of claim 5, wherein the extracted skin colors are respectively represented through the channels in order to form the skin color distribution.

9. The digital image signal processing method of claim 5, wherein the skin color distribution comprises a plurality of Gaussian distributions.

10. The digital image signal processing method of claim 9, wherein the skin color distribution is classified into the plurality of skin color areas using a mean value and a variance value of each of the plurality of Gaussian distributions.

11. The digital image signal processing method of claim 5, wherein the plurality of people comprise people of different ethnic backgrounds.

12. A digital image signal processing apparatus comprising:
an image input unit which inputs an image comprising a plurality of subjects which require different types of color corrections;
an area detector which detects areas of the plurality of subjects;
a color distribution former which forms a color distribution using image information of the areas of the plurality of subjects;
a color area classifier which classifies the color distribution into a plurality of color areas; and
a color corrector which performs corresponding color corrections with respect to areas of the image respectively corresponding to the color areas.

13. The digital image signal processing apparatus of claim 12, further comprising a subject extractor which extracts subjects, which are to be corrected, from the areas of the plurality of subjects.

14. The digital image signal processing apparatus of claim 13, wherein the image information is color information which is represented through each channel.

15. A digital image signal processing apparatus comprising:
an image input unit which inputs an image comprising a plurality of people having different skin colors;
a face area detector which detects face areas of the plurality of people from the image;
a skin color distribution former which forms a skin color distribution using image information of the face areas;
a skin color area classifier which classifies the skin color distribution into a plurality of skin color areas; and
a skin color corrector which performs skin color corrections with respect to skin color areas of the image respectively corresponding to the plurality of skin color areas.

16. The digital image signal processing apparatus of claim 15, wherein the image information of the face areas comprises at least one of luminance, hue and saturation.

17. The digital image signal processing apparatus of claim 15, further comprising a skin color extractor which extracts skin colors using the image information of the face areas.

18. The digital image signal processing apparatus of claim 17, wherein the skin color distribution former respectively represents the extracted skin colors through respective channels in order to form the skin color distribution.

19. The digital image signal processing apparatus of claim 15, wherein the skin color distribution comprises a plurality of Gaussian distributions.

20. The digital image signal processing apparatus of claim 15, wherein the plurality of people comprise people of different ethnic backgrounds.
